(19) United States
(12) Patent Application Publication
(10) Pub. No.: US 2008/0246688 A1
(43) Pub. Date: Oct. 9, 2008

(54) COMBINATION OF PORTABLE COMPUTER AND ANTENNA

(76) Inventors: Mei-Hung CHIANG, Taipei (TW); Yen-Liang Su, Taipei (TW)

Correspondence Address: HDSL, 4331 STEVENS BATTLE LANE, FAIRFAX, VA, 22033, US

(21) Appl. No.: 11/696,347

(22) Filed: Apr. 4, 2007

(51) Int. Cl. H01Q 1/08; H01Q 1/10

(52) U.S. Cl. 343/881

(57) ABSTRACT

A combination of a portable computer and an antenna that can be used to receive wireless signals includes a portable computer and an antenna. One side of the casing of the screen of the portable computer is provided with a trough. The antenna has a connecting base that is pivotably connected in the trough and electrically connected with the computer. An elongated piece body extends from one end of the connecting base. The piece body is provided with electronic circuit therein for acting as a signal reception zone. Via the connecting base, the piece body is electrically connected with the portable computer. Both sides of the piece body are provided with an accommodating trough, respectively. A rod-like antenna is pivotably connected into each accommodating trough. By adjusting the angle and the position of the antenna, the portable computer can receive wireless signals.

### BACKGROUND OF THE INVENTION

1. Field of the Invention

The present invention relates to an antenna, and in particular to an antenna that can be fixed on a portable computer.

2. Description of Prior Art

With the advancement of modern technology, the hardware of the computer has been developed to a mature stage of miniaturization and applied to various fields. Not only in industry and commerce, the computer is widely used in every family and becomes one of the sources of life entertainment. The rise and development of Internet indeed makes the computer to become an important part of life entertainment. Since the Internet is able to transmit information all over the world, people can receive various kinds of information by using the computer. Even, the computer can receive movies or television programs via the Internet, which is a significant progress.

During the development of the Internet, wireless technology brings the capability of Internet to a nearly boundless extent. Therefore, via the transmission of wireless signals, a user can use a portable computer to receive the wireless signals or information at any place (indoors or outdoors) no mater whether there is an Internet cable or not. In order to receive the wireless signals completely, the hardware and software within the computer should be properly set. Further, it is necessary to provide with a reception antenna.

In the past, since a common portable computer is not provided with a suitable hardware for the wireless signal technology, an external antenna should be additionally provided to receive the wireless signals. Therefore, it is necessary for the user to carry an additional reception antenna so as to access the wireless Internet source or receive other wireless signals. If the user forgets to carry the reception antenna, it is impossible to receive the wireless signals and thus to access the intended website. Further, another drawback of the reception antenna is to occupy an additional USB port, which becomes a trouble when the number of USB ports is not enough.

The later-developed portable computer is additionally provided with a built-in antenna. Further, in order not to affect the external appearance of the portable computer, such a built-in antenna is usually hidden in a certain position within the computer. Although this solution can solve the inconvenience of the conventional reception antenna and does not occupy a connecting port, the angle of such kind of hidden antenna cannot be adjusted when the reception of signals is not good. Therefore, the user has to adjust the position of the portable computer so as to receive the wireless signals completely, which is also a problem for the user.

### SUMMARY OF THE INVENTION

In view of the above drawbacks, the present invention is to provide a combination of a portable computer and an antenna that can be fixed on the computer. Via an adjustable antenna that can be connected flatly or folded on the casing of the portable computer, the external appearance of the portable computer will not be affected. Further, the user can adjust the angle of the antenna directly to an optimal one for receiving signals, so that the user can access the Internet source or receive the signals at different places.

In order to achieve the above objects, the present invention provides a combination of a portable computer and an antenna, which comprises a portable computer and an antenna. One side of the casing of the screen of the portable computer is provided with a trough. The antenna has a connecting base that is pivotably connected in the trough and electrically connected with the computer. An elongated piece body extends from one end of the connecting base. The piece body is provided with electronic circuit therein for acting as a signal reception zone. Via the connecting base, the piece body is electrically connected with the portable computer. Both sides of the piece body are provided with an accommodating trough, respectively. A rod-like antenna is pivotably connected into each accommodating trough. By adjusting the positions of the antenna and the rod-like antenna, the portable computer can receive wireless signals.

### BRIEF DESCRIPTION OF THE DRAWINGS

FIG. 1 is an exploded perspective view showing the structure of the present invention;

FIG. 2 is an assembled view of the present invention;

FIG. 3 is a schematic view (I) showing the operation of the present invention;

FIG. 4 is a schematic view (II) showing the operation of the present invention;

FIG. 5 is a schematic view showing the structure of another embodiment of the present invention;

FIG. 6 is an exploded perspective view showing the structure of a further embodiment of the present invention;

FIG. 7 is a schematic view (I) showing the operation of still a further embodiment of the present invention; and

FIG. 8 is a schematic view (II) showing the operation of still a further embodiment of the present invention.

### DETAILED DESCRIPTION OF THE INVENTION

The technical contents of the present invention will be described with reference to the accompanying drawings.

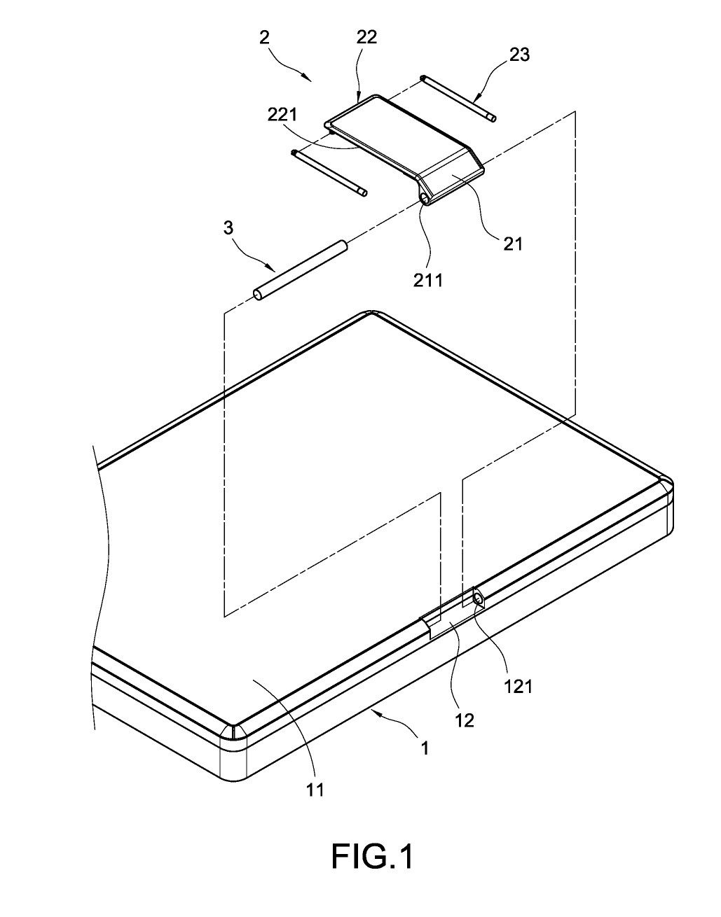

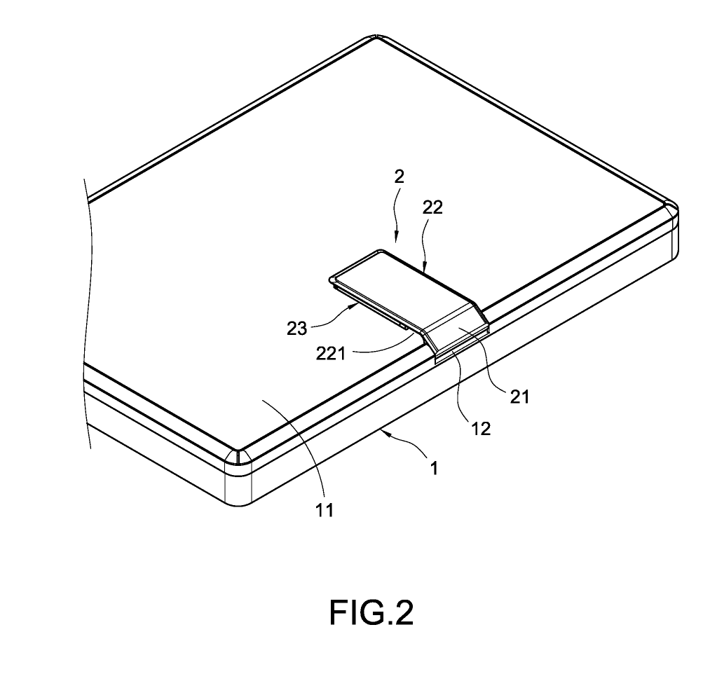

FIG. 1 and FIG. 2 are an exploded perspective view and an assembled view showing the structure of the present invention, respectively. As shown in these figures, the present invention includes a portable computer 1 and an antenna 2. One side of an outer surface of the casing of a screen 11 of the computer 1 is provided with a trough 12. In the present embodiment, the trough is provided on a middle position of the front side. Both ends of the trough 12 are provided with a penetrating hole 121, respectively. The antenna 2 is formed into an elongated shape and has a connecting base 21. In the present embodiment, the connecting base 21 is formed into a plate for being tightly connected into the trough 12. Further, the connecting base 21 has a penetrating trough 211 for allowing a pivot 3 to be penetrated therein. The pivot 3 is pivotably connected to the connecting base 21 and the penetrating holes on both ends of the trough 12, so that the connecting base 21 is able to rotate. Further, an elongated piece body 22 extends outwardly from the connecting base 21. The interior of the piece body 22 is provided with electronic circuit to form an electric wave reception zone. The electronic circuit is electrically connected with the connecting base 21, so that the antenna 2 can be electrically connected with the portable computer 1 via the connecting base 21. In this way, the wireless signals received by the antenna 2 can be transmitted into the portable computer 1. The left and right sides of the piece body 22 are provided with an accommodating trough 221, respectively. The interior of each accommodating trough 221 is pivotably provided with a telescopic rod-like antenna 23 for increasing the intensity and range of electric wave reception of the piece body 22. Via this arrangement, after the connecting base 21 is pivotably connected to the trough 21 of the computer 1, the piece body 22 of the antenna 2 can be connected onto the outer surface of the screen 11 of the computer 1 flatly, as shown in the assembled view of FIG. 2.

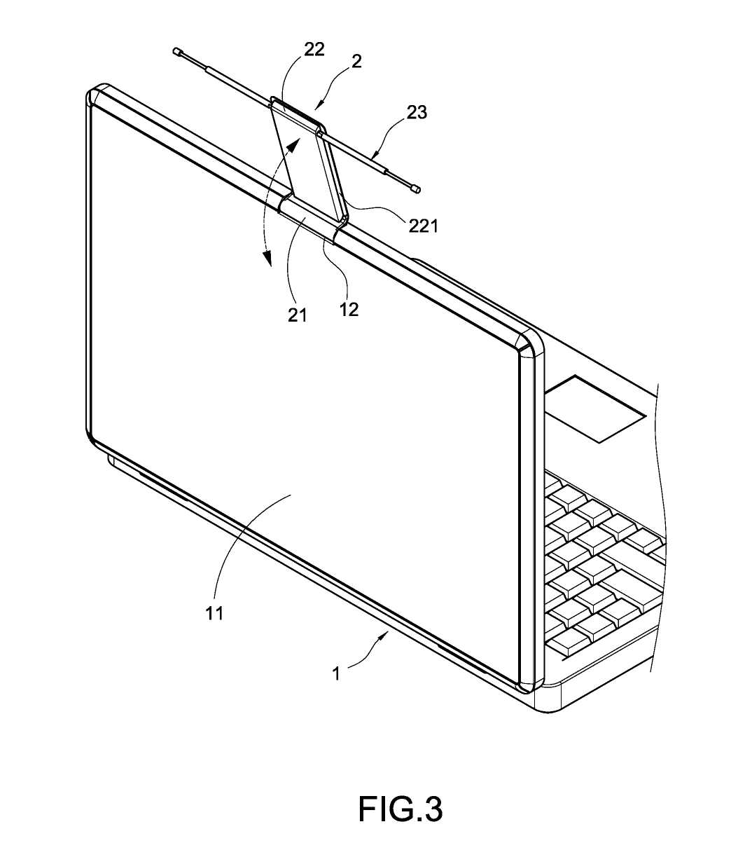

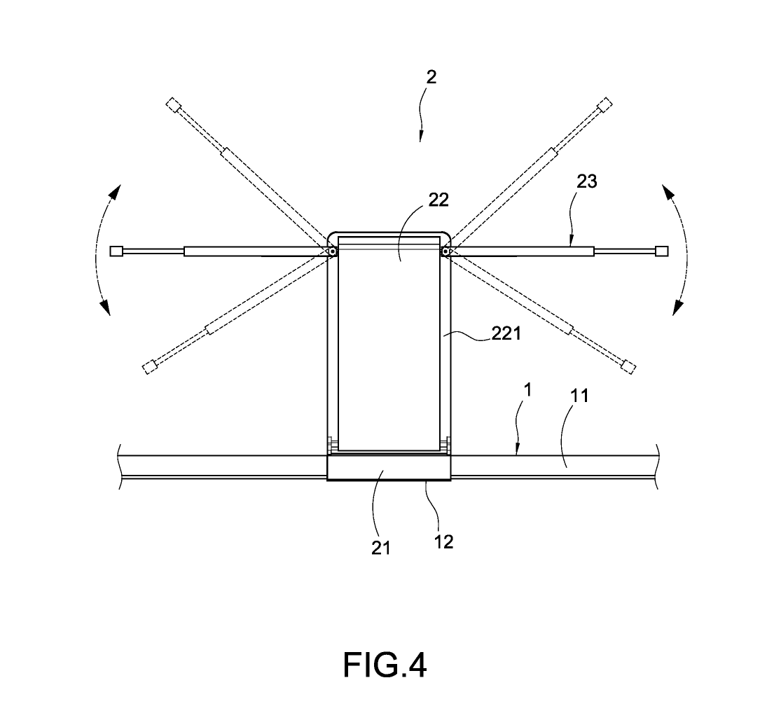

With reference to FIGS. 3 and 4, they are schematic views showing the operation of the present invention. As shown in the drawings, when a user operates the portable computer, the antenna 2 acts to receives wireless signals and transmit the signals into the portable computer 1. The user can turn the piece body 22 connected on the outer surface of the screen 11 upwardly to a proper position via the connecting base 21 of the antenna 2. Further, the user can pull up the rod-like antennas 23 on both sides of the piece body 22. Also, the length of the rod-like antenna 23 can be extended so as to increase the range and intensity of the wireless signals that can be received by the antenna 2. Furthermore, as indicated by the arrow in FIG. 4, the vertical angle of the rod-like antenna 23 can be arbitrarily adjusted in a range of 180 degrees.

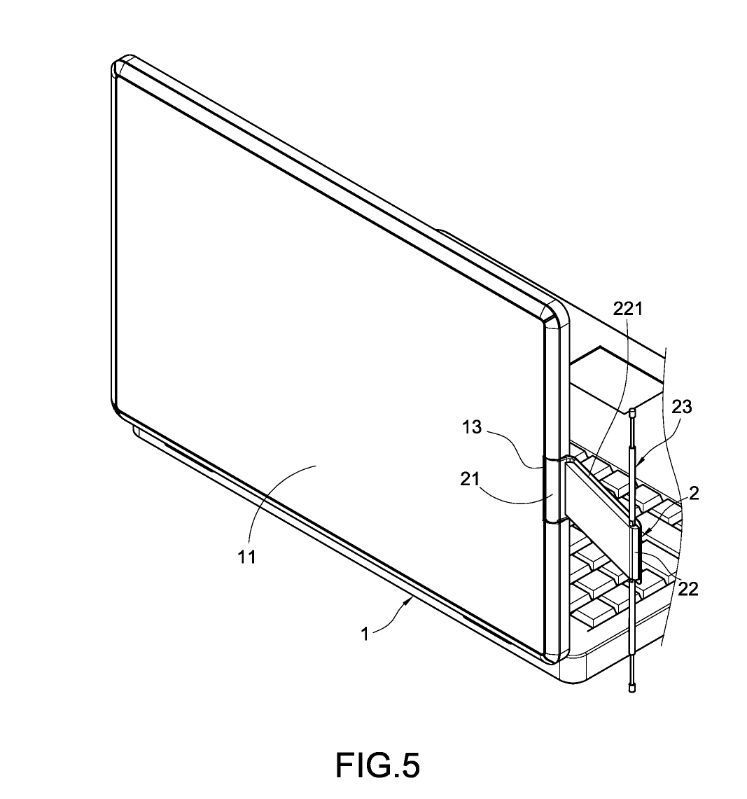

With reference to FIG. 5, it shows another embodiment of the present invention. As shown in this figure, in addition to the front side of the outer surface of the screen 11, the antenna can be connected with the portable computer 1 at the right side of the outer surface of the screen 11 via the same structure and way of connecting as those of the above embodiment. Since the antenna 2 is able to rotate, the position of the antenna 2 can be adjusted to an optimal one for receiving the wireless signals when the user operates the portable computer 1.

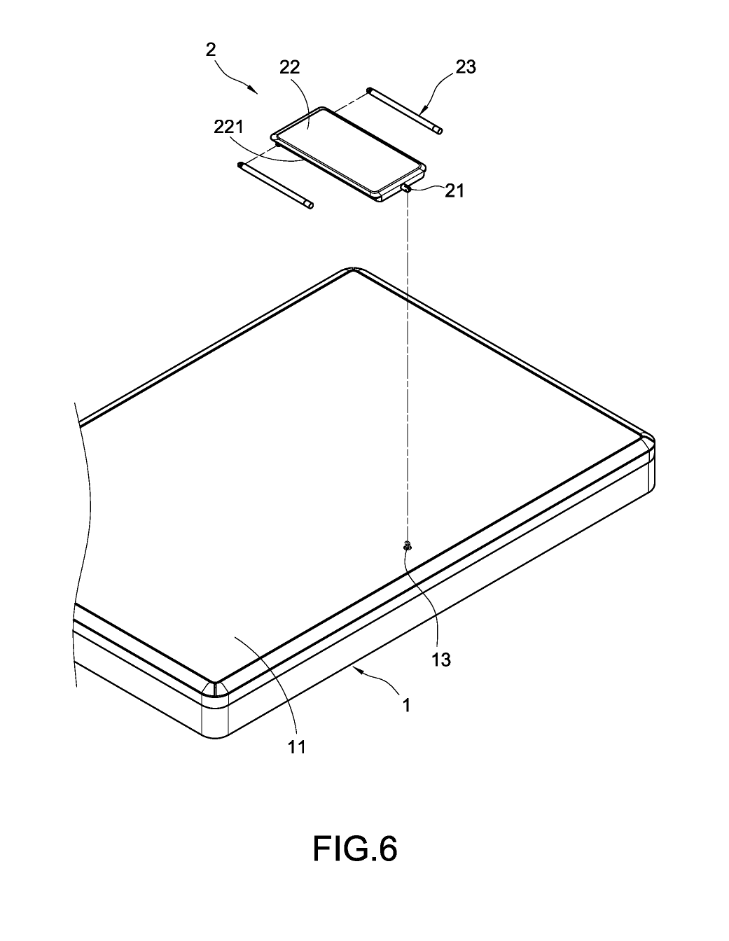

With reference to FIG. 6, it is an exploded perspective view showing the structure of a further embodiment of the present invention. As shown in this figure, the antenna 2 has a connecting base 21 and a piece body 22. The connecting base 21 is formed into a pillar. The interior of the piece body 22 is provided with electronic circuit. The connecting base 21 is electrically connected with the electronic circuit. Both sides of the piece body 22 are provided with a trough 221, respectively. A rod-like antenna 23 is pivotably provided in the trough 221. The rod-like antenna 23 is telescopic and is able to rotate, so that the angle thereof can be adjusted. Further, a rotating base 13 is provided on the outer surface of the casing of the screen 11 of the portable computer 1. The rotating base 12 is electrically and pivotably connected to the connecting base 21 of the antenna 2. The antenna 2 is electrically connected with the interior of the portable computer 1 via the rotating base 13.

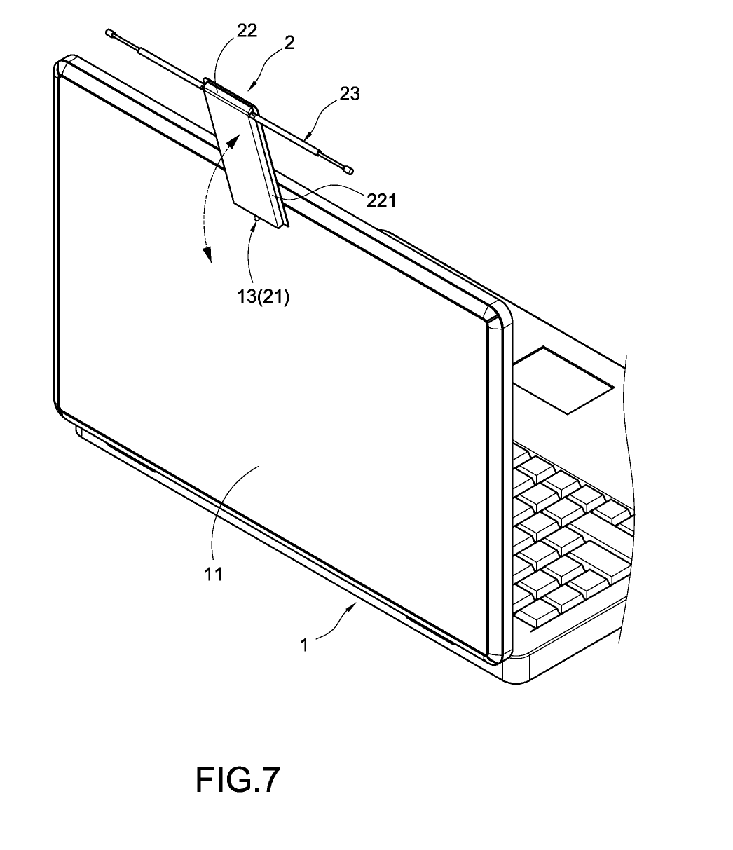

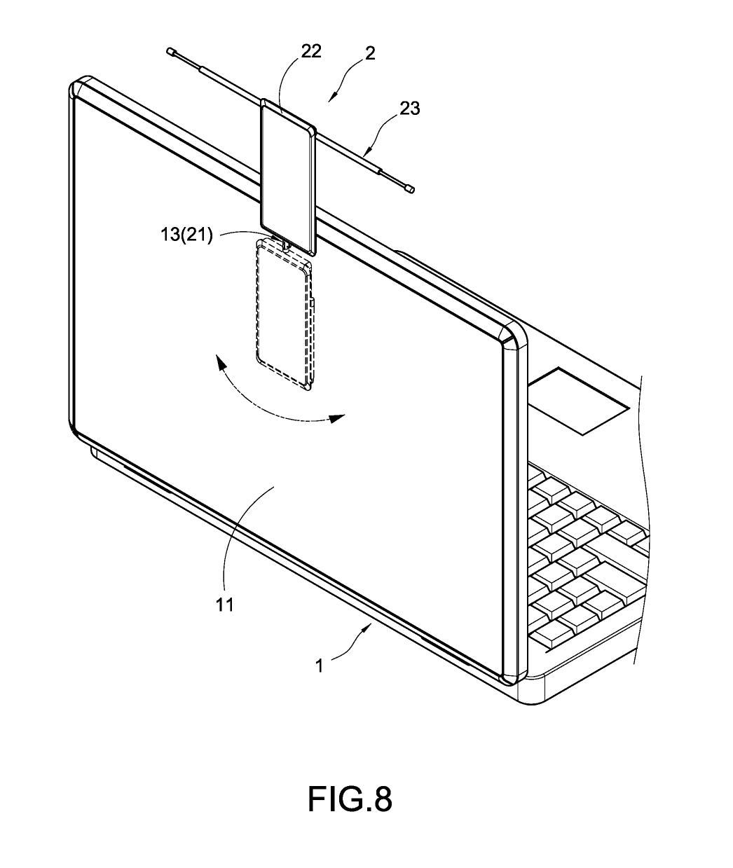

With reference to FIGS. 7 and 8, they are schematic views showing the operation of the present invention. Therefore, when the user operates the portable computer 1 and intends to receive the wireless signals, the user can adjust the position of the antenna 2 in a front-and-back direction. Alternatively, as shown in FIG. 8, the antenna 2 can rotate in a range of 360 degrees and thus can be adjusted to a proper position. In this way, the portable computer 1 can be positioned in an optimal condition for receiving the wireless signals.

Although the present invention has been described with reference to the foregoing preferred embodiments, it will be understood that the invention is not limited to the details thereof. Various equivalent variations and modifications may still occur to those skilled in this art in view of the teachings of the present invention. Thus, all such variations and equivalent modifications are also embraced within the scope of the invention as defined in the appended claims.

What is claimed is:

1. A combination of a portable computer and an antenna, comprising:
a portable computer;
an antenna having a connecting base and a piece body, the connecting base being pivotably connected to the portable computer to allow the antenna to rotate, the piece body being connected flatly on the outer surface of the casing of the computer so as to be folded easily, any side of the piece body being provided with at least one rod-like antenna for increasing the range and intensity of reception of the antenna.

2. The combination of a portable computer and an antenna according to claim 1, wherein the piece body is provided therein with electronic circuit for being electrically connected with the portable computer.

3. The combination of a portable computer and an antenna according to claim 1, wherein one side of the outer surface of the casing of the portable computer is provided with a trough, both ends of the trough are provided with a penetrating hole, the connecting base is received in the trough, the connecting base has a penetrating trough, and a pivot penetrates into the penetrating trough and the penetrating hole.

4. The combination of a portable computer and an antenna according to claim 3, wherein the connecting base is formed into a plate.

5. The combination of a portable computer and an antenna according to claim 1, wherein the outer surface of the portable computer is provided with a rotating base for pivotably connecting to the connecting base of the antenna.

6. The combination of a portable computer and an antenna according to claim 4, wherein the connecting base is formed into a pillar.

7. The combination of a portable computer and an antenna according to claim 1, wherein the rod-like antenna is telescopic.
